(19) United States
(12) Patent Application Publication
(10) Pub. No.: US 2008/0123230 A1
(43) Pub. Date: May 29, 2008

(54) ELECTROSTATIC DISCHARGE CIRCUIT

(76) Inventor: Suk YUN, Kyoungki-do (KR)

Correspondence Address: LADAS & PARRY LLP, 224 SOUTH MICHIGAN AVENUE, SUITE 1600, CHICAGO, IL, 60604, US

(21) Appl. No.: 11/771,441

(22) Filed: Jun. 29, 2007

(30) Foreign Application Priority Data
Jun. 30, 2006 (KR) 10-2006-0061574

(51) Int. Cl. H02H 9/00

(52) U.S. Cl. 361/56

(57) ABSTRACT

An electrostatic discharge (ESD) circuit protects an internal circuit against an electrostatic current. The ESD circuit includes a transfer element connected between the input/output pad and any one of voltage lines. A detector detects a voltage caused by the electrostatic current. A transfer unit transfers the electrostatic current to any one of the voltage lines through a discharge element, which is driven by the detection voltage and which electrically connects the external voltage line and the ground voltage line to form a discharge path to any one of the voltage lines.

### CROSS-REFERENCE TO RELATED APPLICATIONS

The present application claims priority to Korean patent application number 10-2006-061574 filed on Jun. 30, 2006, which is incorporated herein by reference in its entirety.

### BACKGROUND OF THE INVENTION

The present invention relates to a semiconductor integrated circuit, and more particularly, to an electrostatic discharge (ESD) circuit protecting an internal circuit against an electrostatic current.

ESD is a rapid flow of electric current when two mutually insulated objects with significantly different potentials come into direct contact with each other.

When an ESD current is introduced to a semiconductor device, an internal circuit of the device can be damaged. Most semiconductor devices therefore include an ESD protection circuit between an external connection pad and the internal circuits of the device.

FIG. 1 illustrates a conventional, prior art ESD circuit 5.

Referring to FIG. 1, the conventional ESD circuit 5 includes a transfer element 20, a drive element 30, and a discharge element 40.

The transfer element 20 includes a first diode D1 and a second diode D1. By the use of the diode D1, a positive ESD current introduced to an input/output pad 10 is transferred to an external voltage line (or VDD) 50. In order to remove a negative ESD current introduced to the input/output pad 10, the second diode D2 forms a current path from a ground voltage line (or VSS) 60 to the input/output pad 10.

The drive element 30 includes a resistor R1 and a capacitor C1, which are connected in series with each other between VDD 50 and VSS 60. A CMOS inverter 32, connected between the VDD 50 and the VSS 60, is also connected in parallel with the series connected R1 and C1.

The discharge element 40 includes an NMOS transistor, N1 connected in series to and between the VDD 50 and the VSS 60.

When a positive ESD current is introduced to the input/output pad 10, the transfer element 20 transfers the ESD current to VDD 50 via the first diode D1 so that the ESD current cannot be introduced to an internal circuit 70.

An AC current is produced in an initial ESD event, which leads to the flow of an electrostatic current through the capacitor C1. Then, a voltage drop occurs across resistor R1. The drive element 30 supplies to the CMOS inverter 32, a voltage corresponding to the voltage drop across R1. The CMOS inverter 32, acts to amplify the voltage drop across R1 and provides the amplified output voltage to the discharge element 40.

The discharge element 40 is turned on by the CMOS inverter 32 output voltage when the amplified voltage is supplied to the gate of the NMOS transistor N1. VDD 50 and the VSS 60 are thus electrically connected to each other through N1, and ESD current transferred on VDD 50 is discharged to VSS 60. As a result, an internal circuit 70 can be protected against the ESD current.

The conventional ESD circuit 5 of FIG. 1 can start operating before an ESD voltage reaches a junction breakdown point since the discharge element 40 is driven using a voltage drop caused by the AC current. Herein, the AC current is generated during a short period of time when the ESD current initially rises. Disadvantageously, however, except for the rising period of the ESD current, the conventional ESD circuit 5 cannot smoothly continue its operation in some periods, for example, an ESD current peak period, a polling period, etc. As a result, the ESD current may cause damage to the internal circuit 70.

Moreover, a relatively large space is required in a semiconductor device for the conventional ESD circuit 5 because several circuit elements are required to drive the discharge element 40. For example, the resistor R1, the capacitor C1, the CMOS inverter 32, are required to form the drive element 30. Thus, a highly integrated circuit is difficult to achieve using the prior art ESD circuit 5 shown in FIG. 1. Manufacturing costs are also high.

### SUMMARY OF THE INVENTION

The present invention provides an electrostatic discharge (ESD) circuit which reliably operates for the entire time period during which an electrostatic current is generated, thereby protecting an internal circuit.

The present invention also provides an ESD circuit suitable for a highly integrated circuit and capable of being manufactured with low costs by reducing space occupied by elements constituting the ESD circuit.

The present invention also provides an ESD circuit suitable for a high speed operation by reducing the capacitance of an input/output pad.

According to an aspect of the present invention, there is provided an ESD circuit protecting an internal circuit against an electrostatic current introduced from an input/output pad, comprising: a transfer element which is connected between the input/output pad and any one of voltage lines, i.e., an external voltage line or a ground voltage line, and which includes a detector detecting a detection voltage from the electrostatic current and a transfer unit transferring the electrostatic current to any one of the voltage lines; and a discharge element which is driven by the detection voltage, electrically connects the external voltage line and the ground voltage line, and forms a discharge path of the electrostatic current transferred to any one of the voltage lines.

In the aforementioned aspect of the present invention, the discharge element may be constructed such that a first resistor and an NPN bipolar transistor are connected in series between the external voltage line and the ground voltage line, and, in parallel thereto, a PNP bipolar transistor and a second resistor are connected in series between the external voltage line and the ground voltage line, and the base of the NPN bipolar transistor is connected to the collector of the PNP bipolar transistor, thereby forming a latch.

In addition, the transfer element may be constructed of a plurality of diodes each of which an anode is connected towards the input/output pad and a cathode is connected towards the external voltage line.

In addition, the detector may include one or more diodes, each of which an anode is connected toward the input/output pad and a cathode is connected towards the transfer unit, and detect a detection voltage corresponding to the number of the diodes.

In addition, the detector may regulate the number of the diodes so that the detection voltage is higher than an operation voltage of a semiconductor device.

In addition, the detection voltage may be transferred to the common node at which the base of the NPN bipolar transistor is connected to the collector of the PNP bipolar transistor.

In addition, the transfer unit may include one or more diodes, each of which an anode is connected towards the detector and a cathode is connected to the external voltage line, and transfer the electrostatic current generated in the input/output pad to the external voltage line via the detector.

In addition, the transfer element may be constructed of a plurality of diodes each of which a cathode is connected towards the input/output pad and an anode is connected towards the ground voltage line.

In addition, the detector may include one or more diodes, each of which a cathode is connected towards the transfer unit and an anode is connected towards the ground voltage line, and detect a corresponding detection voltage.

In addition, the detection voltage may be transferred to a common node at which the collector of the NPN bipolar transistor is connected to the base of the PNP bipolar transistor.

In addition, the transfer unit may include one or more diodes, each of which a cathode is connected towards the input/output pad and an anode is connected towards the detector, and form a current path from the ground voltage line to the input/output pad via the detector.

According to another aspect of the present invention, there is provided an ESD circuit protecting an internal circuit against an electrostatic current introduced from an input/output pad, comprising: a first transfer element which is connected between the input/output pad and an external voltage line and which includes a first detector detecting a first detection voltage from the electrostatic current generated in the input/output pad and a first transfer unit transferring the electrostatic current to the external voltage line; a second transfer element which is connected between the input/output pad and a ground voltage line and which includes a second detector detecting a second detection voltage to remove the electrostatic current introduced from the input/output pad and a second transfer unit forming a current path from the ground voltage line to the input/output pad via the second detector to remove the electrostatic current; and a discharge element which is driven by the first or second detection voltage and forms a discharge path of the electrostatic current transferred to any one of the voltage lines, i.e., the external voltage line and the ground voltage line, by electrically connecting the external voltage line and the ground voltage line.

In the aforementioned aspect of the present invention, the discharge element may be constructed such that a first resistor and an NPN bipolar transistor are connected in series between the external voltage line and the ground voltage line, and, in parallel thereto, a PNP bipolar transistor and a second resistor are connected in series between the external voltage line and the ground voltage line, and the base of the NPN bipolar transistor is connected to the collector of the PNP bipolar transistor, thereby forming a latch.

In addition, the first transfer element may be constructed of a plurality of diodes each of which an anode is connected towards the input/output pad and a cathode is connected towards the external voltage line.

In addition, the first detector may include one or more diodes, each of which an anode is connected towards the input/output pad and a cathode is connected towards the transfer unit, and detect a first detection voltage corresponding to the number of the diodes.

In addition, the first detector may regulate the number of the diodes so that the detection voltage is higher than an operation voltage of a semiconductor device.

In addition, the first detection voltage may be transferred to the common node at which the base of the NPN bipolar transistor is connected to the collector of the PNP bipolar transistor.

In addition, the second transfer element may be constructed of a plurality of diodes each of which a cathode is connected towards the input/output pad and an anode is connected towards the ground voltage line.

In addition, the second detector may include one or more diodes, each of which a cathode is connected towards the second transfer unit and an anode is connected towards the ground voltage line, and detect a second detection voltage.

In addition, the second detection voltage may be transferred to a common node at which the collector of the NPN bipolar transistor is connected to the base of the PNP bipolar transistor.

In addition, the second transfer unit may include one or more diodes, each of which a cathode is connected towards the input/output pad and an anode is connected towards the second detector, and form a current path from the ground voltage line to the input/output pad via the second detector.

### BRIEF DESCRIPTION OF THE DRAWINGS

FIG. 1 illustrates a conventional electrostatic discharge (ESD) circuit.

FIG. 2 is a circuit diagram of an ESD circuit according to a first embodiment of the present invention.

FIG. 3 is a cross-sectional view related to the ESD circuit of FIG. 2.

FIG. 4 is a circuit diagram of an ESD circuit according to a second embodiment of the present invention.

FIG. 5 is a circuit diagram of an ESD circuit according to a third embodiment of the present invention.

FIGS. 6a to 6d are graphs illustrating simulation results obtained by comparing a conventional ESD circuit and an ESD circuit of the present invention.

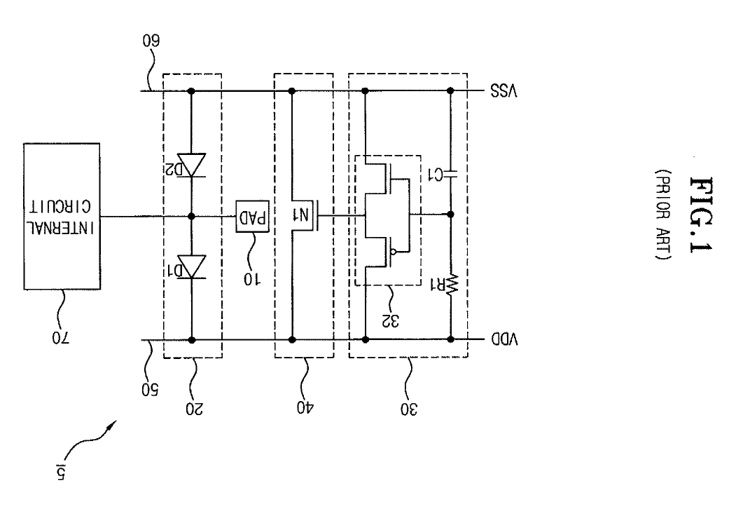

### DESCRIPTION OF SPECIFIC EMBODIMENTS

Hereinafter, exemplary embodiments of the present invention will be described with reference to the accompanying drawings.

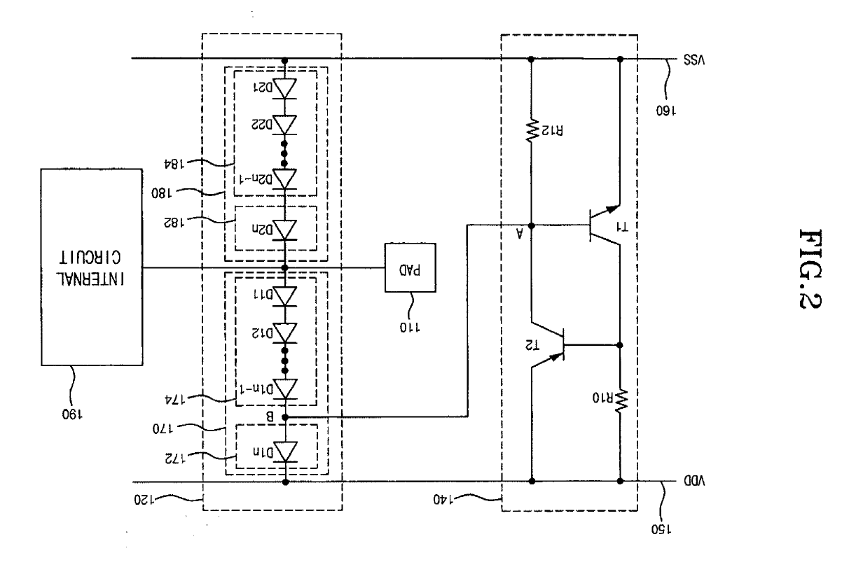

FIG. 2 is a circuit diagram of an electrostatic discharge (ESD) circuit according to a first embodiment of the present invention. The ESD circuit includes a transfer element 120 and a discharge element 140.

The transfer element 120 includes a first diode string 170 and a second diode string 180. The first diode string 170 includes a plurality of diodes D11 to D1n connected in series between an input/output pad 110 and an external voltage line (or VDD) 150. The second diode string 180 includes a plurality of diodes D21 to D2n connected in series between the input/output pad 110 and a ground voltage line (or VSS) 160.

The first diode string 170 is constructed such that a cathode of each diode is connected towards the VDD 150 and an anode of each diode is connected towards the input/output pad 110.

The first diode string 170 further includes a first transfer unit 172 and a first detector 174. The first transfer unit 172 includes one or more diodes, at least including the diode D1n, the cathode of which is directly connected to the VD 150. The first detector 174 includes one or more diodes, at least including the diode D11, the anode of which is directly connected to the input/output pad 110.

In one embodiment, the first detector 174 operates at a voltage higher than the operating voltage of a semiconductor device. The number of the diodes that constitute the first detector 174 is therefore determined or regulated to obtain a detection voltage higher than the operation voltage of the semiconductor device.

For example, if the operation voltage of the semiconductor device is 1.8V, a detection voltage of the first detector 174 has to be higher than 1.8V. If the diodes are silicon, which of course have a forward-biased junction voltage drop of approximately 0.7 volts, the first detector 174 therefore has to include three or more diodes so that the total voltage drop across them exceeds 1.8 V. Three, series-connected silicon diodes will provide a total voltage drop of 2. V, determined by 0.7V*3=2.1V. Stated another way, the a plurality of series-connected and forward-biased diodes have a combined forward-biased voltage drop that effectuates a detection voltage of the first detector 174 that is obtained by the product between the forward-biased operating voltage (about 0.7V) of one diode, multiplied by the number of the diodes. Germanium diodes and diodes formed of other materials will of course have different forward biased junction voltage drops and will require a different number of series connected diodes.

The second diode string 180 is constructed such that an anode of each diode is connected towards the VSS 160 and a cathode of each diode is connected towards the input/output pad 110.

The second diode string 180 further includes a second transfer unit 182 and a second detector 184. The second transfer unit 182 includes one or more diodes, at least including the diode D2n of which a cathode is directly connected to the input/output pad 110. The second detector 184 includes one or more diodes, at least including the diode D21 of which an anode is directly connected to the VSS 160.

The discharge element 140 is constructed such that a first resistor R10 and an NPN bipolar transistor T1 are connected in series between the VDD 150 and the VSS 160, and in parallel thereto, a PNP bipolar transistor T2 and a second resistor R12 are connected in series between the VDD 150 and the VSS 160.

The base of the NPN bipolar transistor T1 is connected to the collector of the PNP bipolar transistor T2, and the collector of the NPN bipolar transistor T1 is connected to the base of the PNP bipolar transistor T2. As a result, the two transistors T1 and T2 are latched, thereby forming a PNPN-type low-voltage triggering silicon-controlled rectifier (LVTSCR) structure.

A common node A at which the base of the NPN bipolar transistor T1, is also connected to the collector of the PNP bipolar transistor T2, and also connected to a common node B at which the first transfer unit 172 is connected to the first detector 174.

When a positive ESD current is introduced from the input/output pad 110, in the first diode string 170 of the transfer element 120, the first detector 174 detects a voltage drop between its both ends caused by the diodes D11 to D1n−1 and supplies a resultant detection voltage to the discharge element 140. In addition, the ESD current passing through the first detector 174 is supplied to the VDD 150 via the first transfer unit 172.

Thereafter, due to the detection voltage supplied to the node A of the NPN bipolar transistor T1, the discharge element 140 is turned on at a voltage lower than an NP junction breakdown voltage that is an operation voltage of the NPN bipolar transistor T1.

This promotes the operation of the PNP bipolar transistor T2 which forms a latch with the NPN bipolar transistor T1. Thus, the VDD 150 and the VSS 160 are electrically connected to each other, thereby forming a discharge path.

As a result, a discharge operation is continuously performed during the generation of the ESD current. Hence, an internal circuit 190 can be reliably protected against the ESD current.

Since the diodes constituting the first and second diode strings 170 and 180 of the transfer element 120 are connected in series to the input/output pad 110, there is an advantage in that the capacitance of the input/output pad 110 decreases.

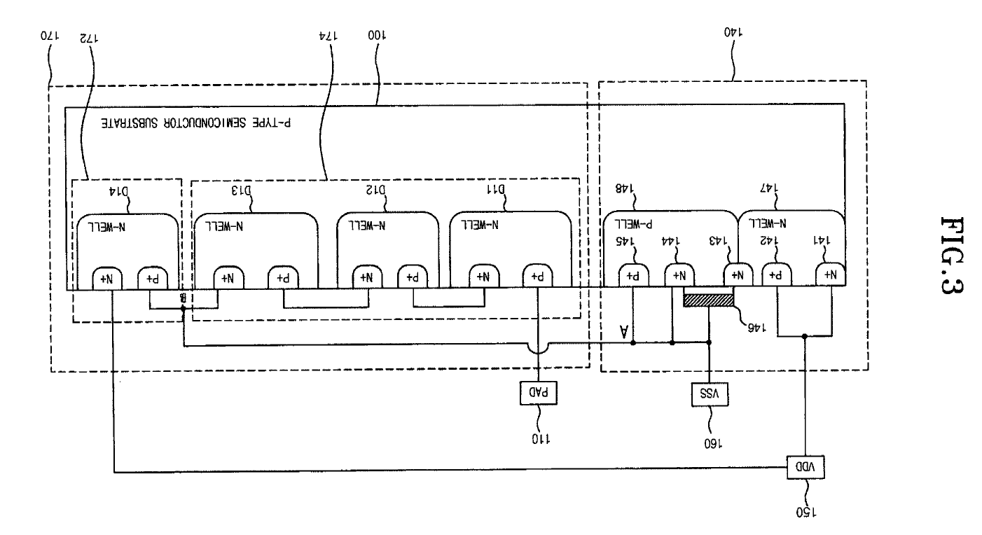

FIG. 3 is a cross-sectional view related to the ESD circuit of FIG. 2 when the operation voltage of the semiconductor device is 1.8V.

As described above, the number of the diodes of the first transfer unit 172 has to be three or more when the operation voltage is 1.8V. Thus, when including the diode of the first detector 174, the number of the diodes constituting the first diode string 170 is four or more.

In a predetermined area of a P-type semiconductor substrate 100, the first diode string 170 shown in FIG. 2, is connected between the input/output pad 110 and the VDD 150 is formed. Adjacent to the first diode string 170, the discharge element 140 shown in FIG. 2 is connected between the VDD 150 and the VSS 160 is formed.

The discharge element 140 is formed with an N-well 147 and a P-well 148 formed in a predetermined area of the P-type semiconductor substrate 100. An N+ area 141 and a P+ area 142 are connected to the VDD 150 and are formed inside the N-well 147.

A gate 146 is formed on a predetermined area of the P-type semiconductor substrate 100. An N+ area 143 and an N+ are 144 are formed below the gate 146 at both ends of the gate 146. The N+ area 143 is formed at the boundary between the N-well 147 and the P-well 148. The N+ area 144 is formed inside the P-well 148.

A P+ area 145 is formed inside the P-well 148 and is spaced apart from the N+ area 144 by a predetermined distance. The N+ area 144 and the P+ area 145 are connected to the VSS 160.

As such, in the discharge element 140, the parasitic NPN bipolar transistor T1, of which a collector, a base, and an emitter respectively correspond to the N-well 147, the P-well 148, and the N+ area 144, and the parasitic PNP bipolar transistor T2, of which an emitter, a base, and a collector respectively correspond to the P+ area 142, the N-well 147, and the P+ area 145, are mutually latched, thereby forming a PNPN-type low voltage threshold silicon controlled rectifier (LVTSCR) structure.

The first diode string 170 is spaced apart from the discharge element 140 formed in a predetermined area of the P-type semiconductor substrate 100. The first to fourth diodes D11, D12, D13, and D14 are sequentially formed in the first diode string 170.

Each of the diodes D11, D12, D13, and D14 is constructed such that a P+ area and an N+ area are formed inside an N-well.

The P+ area of the diode D11 is connected to the input/output pad 110. The N+ area of the diode D11 is connected to the P+ area of the adjacent diode D12. The N+ area of the diode D12 is connected to the P+ area of the diode D13. Likewise, the N+ area of the diode D13 is connected to the P+ area of the last diode D14. The last diode D14 serves as the first detector 174. The N+ area of the diode D14 is connected to the VDD 150. The common node B is positioned between the last diode D14 and the adjacent diode 13 and is connected to the P+ area 145 of the discharge element 140

When an ESD current is introduced from the input/output pad 110, the first detector 174 detects a voltage drop resulted from the first to third diodes D11, D12, and D13, and supplies a resultant detection voltage to the P+ area 145 of the discharge element 140. The first transfer unit 172 transfers the ESD current passing through the first detector 174 to the VDD 150.

Thereafter, due to the detection voltage introduced to the P+ area 145, the NPN bipolar transistor T1 starts its operation at a voltage lower than an NP junction breakdown voltage. This promotes the operation of the PNP bipolar transistor T2 latched with the NPN bipolar transistor T1, and the ESD current transferred to the VDD 150 is discharged through the VSS 160, thereby protecting the internal circuit.

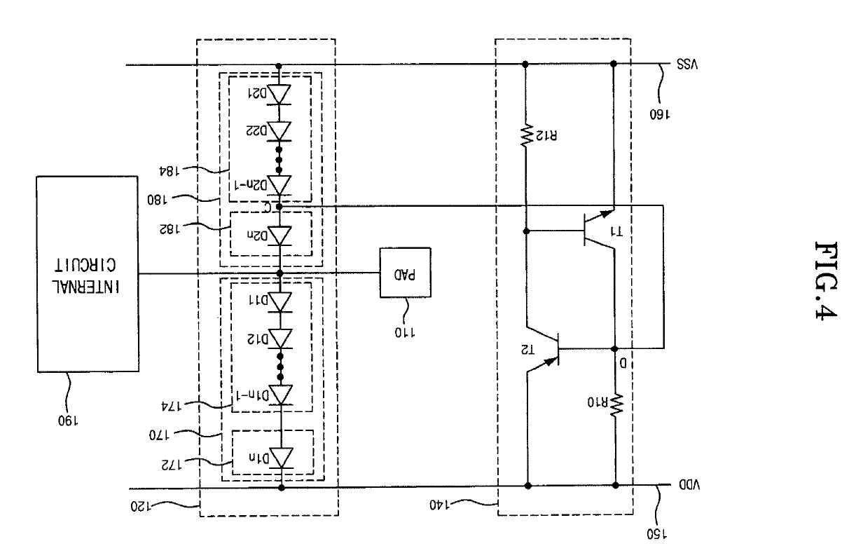

FIG. 4 is a circuit diagram of an ESD circuit according to a second embodiment of the present invention.

Referring to FIG. 4, similar to the first embodiment, the ESD circuit includes a transfer element 120 and a discharge element 140.

Thus, as described above, the transfer element 120 includes a first diode string 170 and a second diode string 180. The first diode string 170 includes a plurality of diodes D11 to D1n connected in series between an input/output pad 110 and an external voltage line (or VDD) 150. The second diode string 180 includes a plurality of diodes D21 to D2n connected in series between the input/output pad 110 and a ground voltage line (or VSS) 160.

The discharge element 140 is constructed such that a first resistor R10 and an NPN bipolar transistor T1 are connected in series between the VDD 150 and the VSS 160, and in parallel thereto, a PNP bipolar transistor T2 and a second resistor R12 are connected in series between the VDD 150 and the VSS 160. The base of the NPN bipolar transistor T1 is connected to the collector of the PNP bipolar transistor T2, and the collector of the NPN bipolar transistor T1 is connected to the base of the PNP bipolar transistor T2. As a result, the NPN bipolar transistor T1 and the PNP bipolar transistor T2 are mutually latched, thereby forming a PNPN-type LVTSCR structure.

In the second embodiment, a detection voltage is detected at a common node C at which the second transfer unit 182 is connected to the second detector 184 of the second diode string 180. The detection voltage is supplied to a common node D at which the collector of the NPN bipolar transistor T1 is connected to the base of the PNP bipolar transistor T2.

Now, the operation of the ESD circuit according to the second embodiment of the present invention will be described with reference to FIG. 4. When a negative ESD current is introduced from the input/output pad 110, in the second diode string 180, the second detector 184 detects a voltage drop between its both ends caused by the plurality of diodes D21 to D2n−1 connected to the VSS 160 and supplies a resultant detection voltage to the discharge element 140. Also, a current path is formed from the VSS 160 to the input/output pad 110 via the second transfer unit 182.

Thereafter, due to the detection voltage supplied to the common node D, the discharge element 140 is turned on at a voltage lower than a PN junction breakdown voltage that is an operation voltage of the PNP bipolar transistor T2. This promotes the operation of the NPN bipolar transistor T1 which forms a latch with the PNP bipolar transistor T2. Thus, the VDD 150 and the VSS 160 are electrically connected to each other, thereby forming a discharge path. As a result, a discharge operation is continuously performed during the generation of the ESD current. Hence, an internal circuit 190 can be reliably protected against the ESD current.

FIG. 5 is a circuit diagram of an ESD circuit according to a third embodiment of the present invention.

Referring to FIG. 5, similar to the first and second embodiments, the ESD circuit includes a transfer element 120 and a discharge element 140.

The transfer element 120 includes a first diode string 170 and a second diode string 180. The first diode string 170 includes a plurality of diodes D11 to D1n connected in series between an input/output pad 110 and an external voltage line (or VDD) 150. The second diode string 180 includes a plurality of diodes D21 to D2n connected in series between the input/output pad 110 and a ground voltage line (or VSS) 160.

The discharge element 140 is constructed such that a first resistor R10 and an NPN bipolar transistor T1 are connected in series between the VDD 150 and the VSS 160, and in parallel thereto, a PNP bipolar transistor T2 and a second resistor R12 are connected in series between the VDD 150 and the VSS 160. The NPN bipolar transistor T1 forms a latch with the PNP bipolar transistor T2, thereby forming a PNPN-type LVTSCR structure.

In the ESD circuit of the third embodiment, a common node B between the first detector 174 of the first diode string 170 and the first transfer unit 172 is connected to a common node A of the discharge element 140. A common node C between the second detector 184 of the second diode string 180 and the second transfer unit 182 is connected to a common node D of the discharge element 140.

As a result, whenever the EDS current is introduced to the input/output pad 110, an operation voltage of the discharge element 140 is reduced, resulting in a fast operation. In addition, a discharge operation is smoothly performed for the entire time period during which the ESD current is generated.

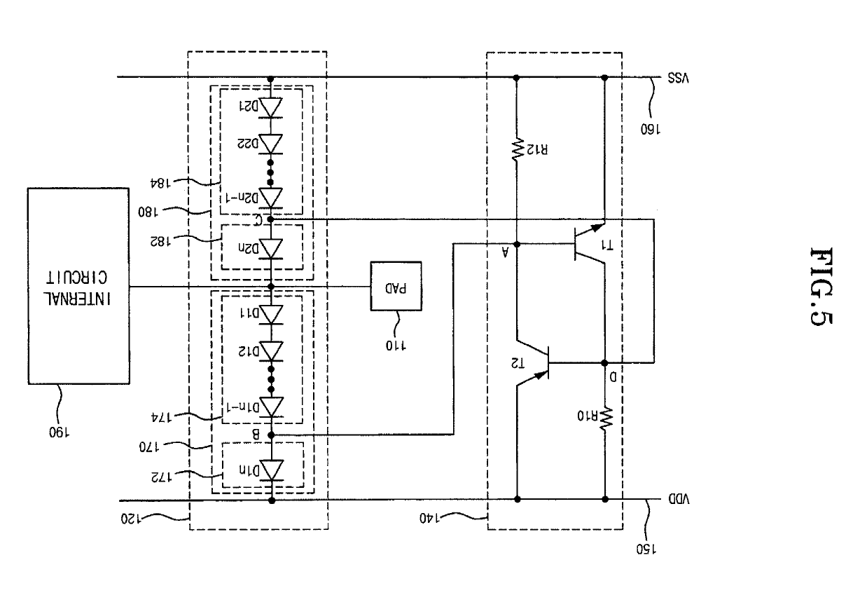

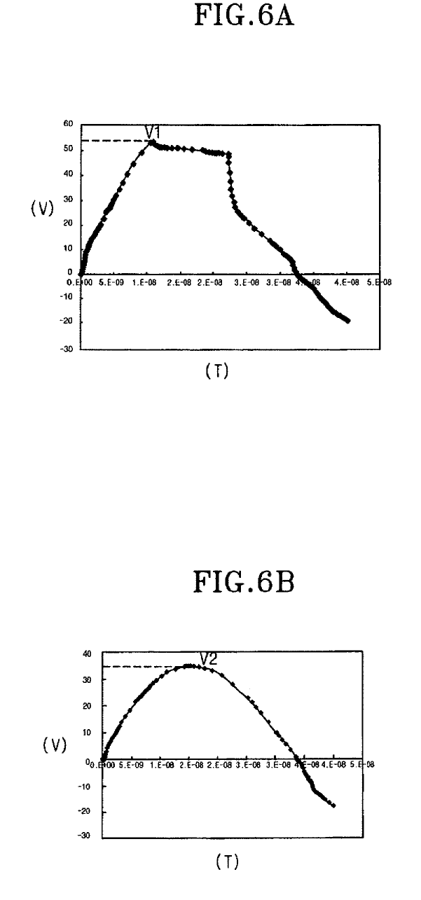

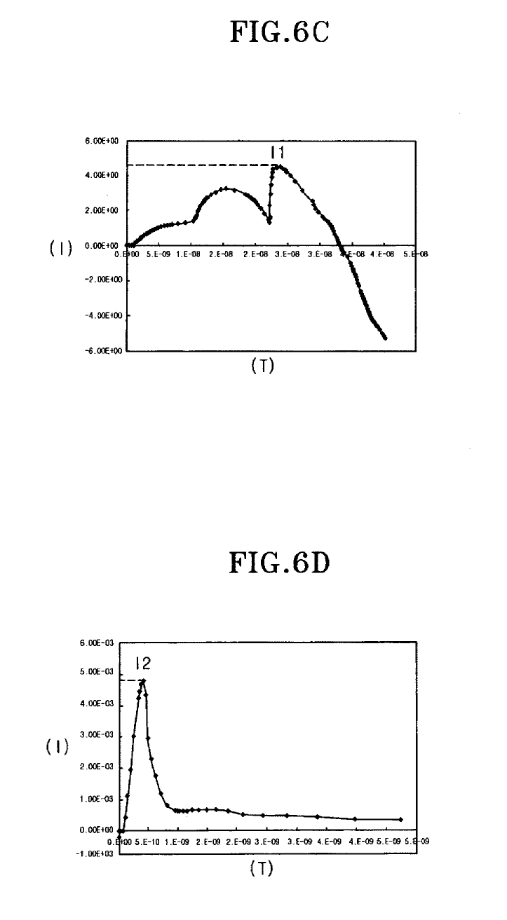

FIGS. 6a to 6d are graphs illustrating simulation results obtained by comparing a conventional ESD circuit and an ESD circuit of the present invention.

These graphs show voltage variation at an input/output pad when a machine model ESD pulse is applied to a circuit, which is obtained using sequoia simulation. The simulation is performed under the condition that a ground voltage line is set to a ground level, and the machine model ESD pulse is applied to the input/output pad at 650V.

Referring FIGS. 6a and 6b, in the conventional ESD circuit (FIG. 6a), the voltage at the input/output pad rises up to 54V, whereas in the ESD circuit of the present invention (FIG. 6b), the voltage at the input/output pad rises up to 35V. This result shows that the ESD circuit of the present invention can further effectively protect its internal circuit.

Referring to FIGS. 6c and 6d, in the conventional ESD circuit (FIG. 6c), a current I1 of a backward diode connected between the input/output pad and the ground voltage line rises up to 4.5 A, whereas in the ESD circuit of the present invention (FIG. 6d), a current I2 of the backward diode rises up to 4.7 mA. This result shows that the ESD circuit of the present invention can significantly prevent deterioration of backward diode characteristics. This result also shows that the ESD circuit of the present invention can further effectively protect its internal circuit.

According to the present invention, an electrostatic discharge (ESD) circuit reliably operates for the entire time period during which an electrostatic current is generated, thereby protecting an internal circuit.

In addition, the ESD circuit is suitable for a highly integrated circuit and is manufactured with low cost by reducing space occupied by elements constituting the ESD circuit.

In addition, the ESD circuit is suitable for a high speed operation by reducing the capacitance of an input/output pad.

What is claimed is:

1. An electrostatic discharge (ESD) circuit for protecting an internal circuit of a semiconductor device against an electrostatic current introduced from an input/output pad, comprising:
a transfer element which is connected between the input/output pad and at least one of an external voltage line and a ground voltage line, the transfer element including a detector for detecting a voltage from the electrostatic current and a transfer unit that transfers electrostatic current to any one of the voltage lines; and
a discharge element, which is driven by the detection voltage, and which electrically connects the external voltage line to the ground voltage line to form a discharge path of the electrostatic current transferred to any one of the voltage lines.

2. The ESD circuit according to claim 1, wherein the discharge element is constructed such that a first resistor and an NPN bipolar transistor are connected in series between the external voltage line and the ground voltage line, and, in parallel with: a PNP bipolar transistor connected in series with a second resistor that are also connected between the external voltage line and the ground voltage line, and the base of the NPN bipolar transistor being connected to the collector of the PNP bipolar transistor, thereby forming a latch.

3. The ESD circuit according to claim 2, wherein the detection voltage is transferred to a common node at which the base of the NPN bipolar transistor is connected to the collector of the PNP bipolar transistor.

4. The ESD circuit according to claim 1, wherein the transfer element is constructed of a plurality of diodes, each of which has an anode and a cathode, the anodes of which are each connected towards the input/output pad and a cathode is connected towards the external voltage line.

5. The ESD circuit according to claim 1, wherein the detector includes one or more diodes, each of which an anode is connected toward the input/output pad and a cathode is connected towards the transfer unit, and detects a detection voltage corresponding to the number of the diodes.

6. The ESD circuit according to claim 5, wherein the number of series connected diodes have a combined forward biased voltage drop that effectuates a detection voltage higher than an operation voltage of a semiconductor device.

7. The ESD circuit according to claim 5, wherein the detection voltage is transferred to the common node at which the base of the NPN bipolar transistor is connected to the collector of the PNP bipolar transistor.

8. The ESD circuit according to claim 1, wherein the transfer unit includes one or more diodes, each of which an anode is connected towards the detector and a cathode is connected to the external voltage line, and transfers the electrostatic current generated in the input/output pad to the external voltage line via the detector.

9. The ESD circuit according to claim 1, wherein the transfer element is constructed of a plurality of diodes each of which a cathode is connected towards the input/output pad and an anode is connected towards the ground voltage line.

10. The ESD circuit according to claim 1, wherein the detector includes one or more diodes, each of which a cathode is connected towards the transfer unit and an anode is connected towards the ground voltage line, and detects a corresponding detection voltage.

11. The ESD circuit according to claim 10, wherein the detection voltage is transferred to a common node at which the collector of the NPN bipolar transistor is connected to the base of the PNP bipolar transistor.

12. The ESD circuit according to claim 1, wherein the transfer unit includes one or more diodes, each of which a cathode is connected towards the input/output pad and an anode is connected towards the detector, and forms a current path from the ground voltage line to the input/output pad via the detector.

13. An electrostatic discharge (ESD) circuit protecting an internal circuit against an electrostatic current introduced from an input/output pad, comprising:
a first transfer element which is connected between the input/output pad and an external voltage line and which includes a first detector detecting a first detection voltage from the electrostatic current generated in the input/output pad and a first transfer unit transferring the electrostatic current to the external voltage line;
a second transfer element which is connected between the input/output pad and a ground voltage line and which includes a second detector detecting a second detection voltage to remove the electrostatic current introduced from the input/output pad and a second transfer unit forming a current path from the ground voltage line to the input/output pad via the second detector to remove the electrostatic current; and
a discharge element which is driven by the first or second detection voltage and forms a discharge path of the electrostatic current transferred to any one of the voltage lines, i.e., the external voltage line and the ground voltage line, by electrically connecting the external voltage line and the ground voltage line.

14. The ESD circuit according to claim 13, wherein the discharge element is constructed such that a first resistor and an NPN bipolar transistor are connected in series between the external voltage line and the ground voltage line, and, in parallel thereto, a PNP bipolar transistor and a second resistor are connected in series between the external voltage line and the ground voltage line, and the base of the NPN bipolar transistor is connected to the collector of the PNP bipolar transistor, thereby forming a latch.

15. The ESD circuit according to claim 14, wherein the first detection voltage is transferred to a common node at which the base of the NPN bipolar transistor is connected to the collector of the PNP bipolar transistor.

16. The ESD circuit according to claim 14, wherein the second detection voltage is transferred to a common node at which the collector of the NPN bipolar transistor is connected to the base of the PNP bipolar transistor.

17. The ESD circuit according to claim 13, wherein the first transfer element is constructed of a plurality of diodes each of which an anode is connected towards the input/output pad and a cathode is connected towards the external voltage line.

18. The ESD circuit according to claim 13, wherein the first detector includes one or more diodes, each of which an anode is connected towards the input/output pad and a cathode is connected towards the transfer unit, and detects a first detection voltage corresponding to the number of the diodes.

19. The ESD circuit according to claim 18, wherein the first detector regulates the number of the diodes so that the detection voltage is higher than an operation voltage of a semiconductor device.

20. The ESD circuit according to claim 18, wherein the first detection voltage is transferred to the common node at which the base of the NPN bipolar transistor is connected to the collector of the PNP bipolar transistor.

21. The ESD circuit according to claim 13, wherein the second transfer element is constructed of a plurality of diodes each of which a cathode is connected towards the input/output pad and an anode is connected towards the ground voltage line.

22. The ESD circuit according to claim 13, wherein the second detector includes one or more diodes, each of which a cathode is connected towards the second transfer unit and an anode is connected towards the ground voltage line, and detects a second detection voltage.

23. The ESD circuit according to claim 22, wherein the second detection voltage is transferred to a common node at which the collector of the NPN bipolar transistor is connected to the base of the PNP bipolar transistor.

24. The ESD circuit according to claim 13, wherein the second transfer unit includes one or more diodes, each of which a cathode is connected towards the input/output pad and an anode is connected towards the second detector, and forms a current path from the ground voltage line to the input/output pad via the second detector.
